(19) United States
(12) Patent Application Publication
(10) Pub. No.: US 2004/0200644 A1
(43) Pub. Date: Oct. 14, 2004

(54) Safe load lifting measurement device

(76) Inventors: Alan Paine, San Dimas, CA (US); Kirk Alyn Buhler, Corona, CA (US)

Correspondence Address: Buhler Associate Patents & Engineering, 2687 Scenic Crest Lane, Corona, CA, 92881-3551, US

(21) Appl. No.: 10/408,824

(22) Filed: Apr. 8, 2003

(51) Int. Cl. G01G 19/08

(52) U.S. Cl. 177/136

(57) ABSTRACT

An apparatus is provided for determining the safe lifting capacity of a lifting machine such as a forklift, lift gate or crane. The apparatus measures numerous parameters of the load including weight of the load, the distance from a base position and the angle of the load. The apparatus then displays the parameters and the ratio of the load to the capacity of the lifting machine. If the load exceeds the capacity of the lifting machine, the parameters of the exceeded capacity are stored in memory. In addition, the time and date of the overload can be stored in memory. The apparatus also includes a user interface where real-time and historical events can be viewed.

### FIELD OF THE INVENTION

The present invention pertains to the field of weight sensing systems and warning systems for lifting equipment. Specifically, the present invention pertains to weighing and sensing systems suited for lifting mechanisms, and machines where the location of the item being lifted can vary or be moved.

### BACKGROUND OF THE INVENTION

There are many different types of equipment that are used to lift or move loads. When these pieces of equipment are designed they have a lifting capacity that the equipment is designed for so damage does not occur to the equipment, the operator, nearby people or structures. When the equipment is sold the manufacturing company will supply specifications and lifting information. The operators that use the equipment are often given classes on the correct use of the equipment to ensure that the equipment is used in a safe manner.

For most of these types of equipment, when a load is being lifted or moved the operator of the equipment is provided with information regarding the lifting capacity of the equipment. This information may include charts or graphs regarding the capacity of the equipment. The operator must use the information provided by the manufacturer to determine if the load being lifted is within the capacity of the machine. There are several issued patents that cover measuring a load being lifted, but none of them cover determining measuring multiple characteristics of the lifting equipment as the load is re-positioned or moved by the lifting equipment.

U.S. Pat. No. 5,666,295 issued to Burns is designed to work with a forklift. This invention measures the pressure in the hydraulic fluid to determine the weight of the load. While this method of measuring the load may be an accurate method for determining the load being lifted it is not capable of determining where the load is located on the blades of the forklift.

U.S. Pat. No. 5,994,650 issued to Eriksson et al. monitors the current to the pump motor to estimate the load being lifted. This patent uses a number of sensors to determine the load and does not use any sensors to determine the location of the load being lifted.

U.S. Pat. Nos. 5,065,829; 5,065,828; and 5,064,008 issued to Smith disclose a measurement system for lifting equipment. These patents cover a method of reducing the vibration and variation of measuring the load, but they all only disclose measuring the total load and do not cover determining where the load is located.

U.S. Pat. No. 5,210,706 issued to Nishiyama discloses a method of measuring a plurality of load cells. The signals are amplified, converted to a digital signal and then analyzed by a micro-controller. The readings from the sensors are summed by the micro-controller to provide a total weight. This patent covers using multiple sensors, but they are all measuring the same weight. It also does not address determining where the load is, the location of the load or the position of the lifting equipment.

What is needed is a measurement device that is capable of both measuring the weight of the load and the location of the load. The ideal device would also measure the position of the equipment including, extension, angle, rotation and the status of any support members such as outriggers. The proposed invention solves this problem by measuring the load, location of the load and the status of additional supports such as outriggers. The proposed invention uses a microprocessor to calculate the interaction of multiple sensors to determine if the load is within the capacity of the load being lifted. In addition, the proposed invention can save events when the capacity was at a maximum or exceeds the maximum to provide feedback to the equipment owner. The invention also contains memory that can store usage and overload information.

### BRIEF SUMMARY OF THE INVENTION

The invention is a device that measures a number of parameters of piece of lifting equipment to determine the load, location of the load and the position of any supports such as outriggers. The information is collected and compared to capacity tables for the equipment to determine if the load is within the capacity of the machine to lift the load. The invention may additionally include a user interface that provides a numerical or graphical representation of the equipment. The invention may also include an audible or visual warning system when the load is near or over the capacity of the equipment. The device may further include memory to store information on the use of the equipment.

### BRIEF DESCRIPTION OF THE SEVERAL VIEWS OF THE DRAWING(S)

FIG. 1 is forklift.

FIG. 2 is truck liftgate.

FIG. 3 is crane.

FIG. 4 is graph of lifting capacity verses load location.

FIG. 5 is graph for crane.

FIG. 6 is block diagram of the invention.

FIG. 7 is a diagram of the user interface.

FIG. 8 is a flow chart showing the program calibration and operation.

### DETAILED DESCRIPTION OF THE INVENTION

Lifting equipment is used for a number different applications. The operators often take classes to operate the equipment. Included in this training is trained is information on the capacity of the equipment based upon where the load is located. This information is also included with the operators manual and may be attached to the side of the equipment. The operator must often rely upon experience to determine if the load is safe to lift. The operator must estimate the weight of the item being lifted from experience or information provided to them. They may also rely on crude sensors to provide information on the equipment. For example, the boom angle is usually determined by lines painted on the boom and with a gravity arm that is welded to the boom. As the boom is inclined, a gravity arm swings to indicate the angle of the boom. This invention discloses the use of multiple sensors located on a piece of lifting equipment to provide an improved method of providing information to the equipment operator and also calculate the interaction of the multiple position sensors to provide better information to the operator. In addition, this devise can save information regarding the loading or overloading of the equipment.

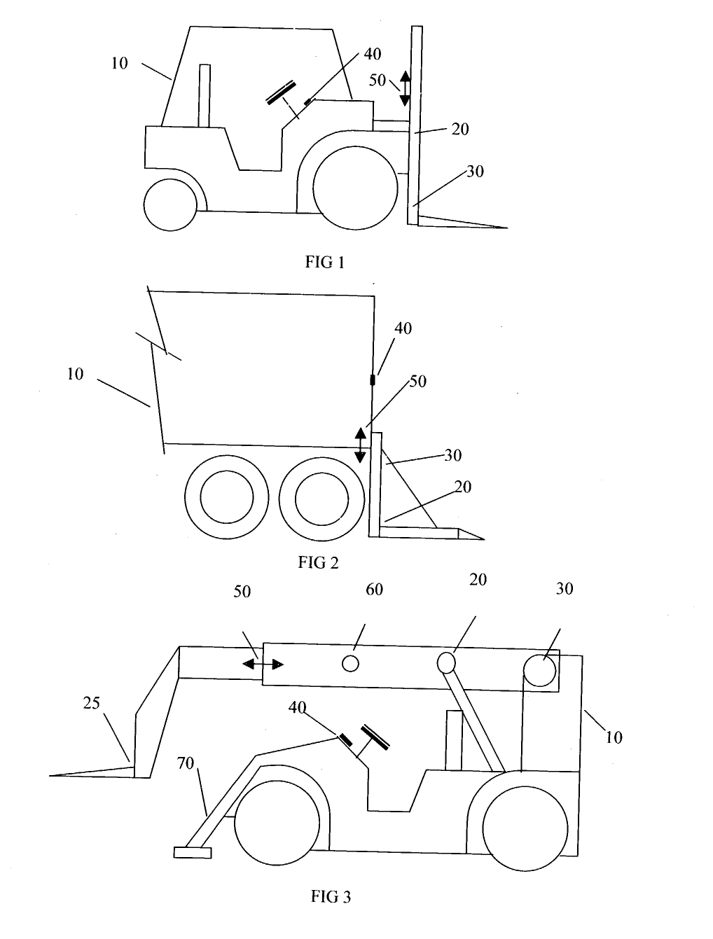

The lifting equipment as shown in FIGS. 1, 2 and 3 includes load sensors 20, 25, and 30 sensors connected or integrated onto a piece of lifting equipment (10). The load and position sensors are connected to a user interface mechanism 40.

The lifting equipment can be a variety of different configurations. FIG. 1 shows the lifting equipment as a forklift, FIG. 2 shows the lifting equipment as a lift gate, FIG. 3 shows the lifting equipment as a crane. While these three different pieces of equipment are show, the invention can be integrated on a variety of other pieces of equipment where the location of the load is not located at a fixed location.

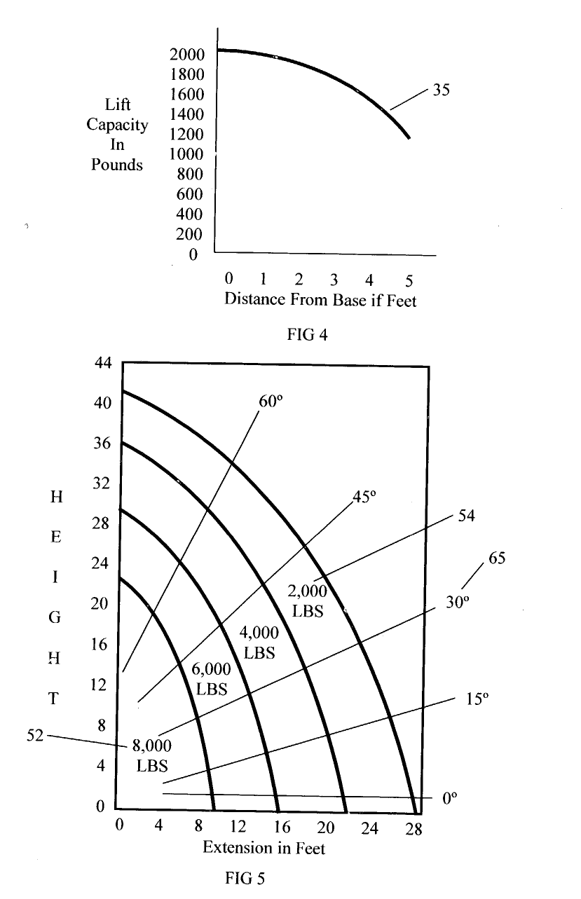

Referring to the forklift in FIG. 1 the equipment contains a load sensor 20 that measures the normal or vertical load. A second sensor 30 measures the bending load based upon how far the load is located from a base location. FIG. 4 shows a graph of the relationship 35, of the bending load as a function of the distance of the load from the base location. In this figure, the capacity at the base is shown as 2,000 pounds. As the load is placed further from the base the capacity of the equipment decreases to 1,200 pounds when the load is placed 5 feet from the base. The bending load placed on the equipment creates additional forces on the equipment that can cause permanent damage if it exceeds the capacity of the machine. In addition to the increased bending load as the load is placed further from the base location the load has a greater ability to tip the piece of equipment over and be a risk to the operator. A sensor can also be placed on the axle or wheels of the lifting equipment to determine if the equipment is in danger of tipping over. Sensor 50 can provide information to the operator on how high the load is lifted. Sensors can be used to determine the extension of the blades of a forklift. This information of the height of the lift can be used to determine if the item will pass through a doorway with limited clearance.

Referring to the lift gate in FIG. 2 the equipment contains a load sensor 30 that determines the vertical load. A second sensor 20, determines the bending load on the gate. As the load is placed further on the end of the gate the bending force places greater load on the mechanics and hydraulics of the gate. If a load is placed next to the body of the truck where the mechanical advantage of the hydraulics and mechanics is the greatest, the lifting capacity of the machine is the greatest. When the same load is placed the furthest from the body of the truck a greater force is placed on the hydraulics and mechanics. At some point damage will occur to the lifting mechanism. Referring again to FIG. 4, you can see that the lifting capacity of the machine varies as a function of how far the load is placed from the body of the truck. Normally a graph similar to FIG. 4 is attached to the back of the lift gate of a truck notifying the operator on the capacity of the lift gate. This assumes that the operator knows the weight of the load and where the load is located in relationship to the body of the truck. The proposed invention uses the information from the two sensors to make calculations to determine if the load on the lift gate is within its capacity. An additional position sensor 50, may be used to determine the extension or height of the lift on the gate on a truck lift gate.

Referring to the crane in FIG. 3 where a load can be lifted from the ground, the boom can be extended, and the load placed at another location. Because the boom can extend from the body the lifting capacity of the equipment is a function of the extension of the boom and the angle of the boom. In a preferred embodiment, one or more sensor(s) 20, 25, 30 are used to determine the strain on the boom. An extension sensor 50 is placed on the extension of the boom to determine how far the boom is extended. An inclinometer sensor 60 is placed on boom to determine the angle of the boom. An additional sensor 70 is placed on an outrigger to determine the position or extension of the outrigger. If the boom can be rotated about the base vehicle an angular or rotation sensor can be used to determine the position of the boom in relationship to the wheels, body and or outriggers. The information from some or all the sensors can be used with look-up tables, mathematical algorithms, or other relationships to determine the operating safety factor, load, or signal the operator of unsafe lifting condition. This information is graphically shown in FIG. 5.

In FIG. 5 the extension of the boom is shown on the x-axis, and the height of the load being lifted is on the y-axis. The graph also shows boom angle on the graph. Item 65 shows a line for the boom being inclined to 30 degrees. Item 52, shows the area that the lifting equipment can operate with a loads of up to 8,000 pounds, and item 54 shows the area where the lifting capacity of the equipment is only 2,000 pounds. You can see from this graph that the information may be difficult for an operator to remember. Often the equipment is being used to lift a load of 6,000 pounds. As the operator moves the load from ground to the second or third floor of a building, they may raise the boom to 45 degrees, and extend the boom to a condition that is not safe, and may cause damage to the equipment. The disclosed invention would monitor all the parameters of the equipment and notify the user by sound, light, or by preventing the lift if the operator tries to operate the equipment in a condition near or beyond the safe capacity of the equipment.

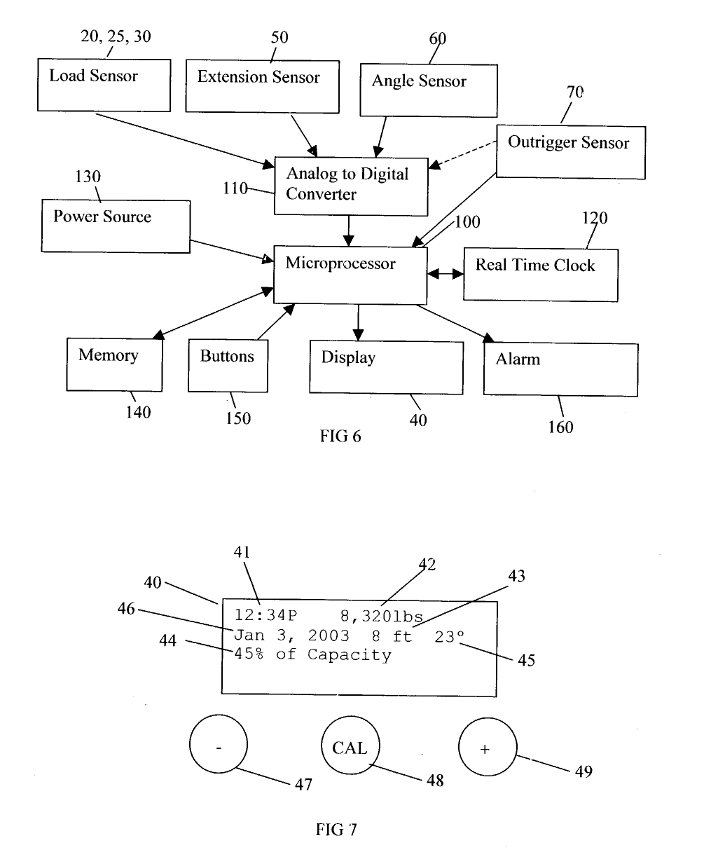

FIG. 6 is a block diagram showing different part of the invention, and how they may be connected. Item 100 is the microprocessor that performs all the computations and takes care of the user interface. The microprocessor may be type of microprocessor including a device with internal or external RAM or ROM memory, internal analog to digital conversion. In the preferred embodiment the microprocessor is made by PIC16LF874 made by Microchip. The power source, item 130, is supplied by the lifting equipment. The power source may be from another battery or from solar or any other type source that provides power. The power to the invention is regulated from 12 volts DC to 5 volts DC, and it also charges a separate power source to maintain the real time clock, item 120, when the vehicle is not turned on. Item 110 is an external analog to digital converter that receives the analog signals from the sensors. Items 20, 25 and 30 are load sensors or strain gauges that measure the load. The load sensor 20 is a sensor that responds to the load. This sensor can be a variety of sensors including strain gauges, load cell, piezo sensor, capacitive sensor, inductive sensor, resistive sensor or any other type of sensor that provides a variable output based upon a varying load. The output from this sensor can be amplified to provide a higher level of signal. The amplifier can have a variable gain or a fixed gain, or any type amplifier or signal conditioner that allows the signal from the sensor to be read by an analog to digital converter or micro-controller. Item 50 is an extension sensor. The extension sensor measures the displacement of the boom or outriggers. The extension sensor can be a strain gauge connected to a spring, to measure the boom, outrigger or other item that moves. The extension sensor could be a potentiometer and as the item moves, the potentiometer is turned. Other type of sensors can also be used that can detect the movement of part of the equipment. Item 60, is an angle sensor that detects the incline of the body of the equipment or movable part of the equipment. In the preferred embodiment, the angle sensor is an inclinometer that is attached to the boom of the crane. Another method of sensing the angle is using a strain gauge and spring. As the position of the equipment changes, the spring is stretched and the angle can be determined. Item 70 is a sensor that detects the status, position, or extension of an outriggers. The sensor in the preferred embodiment is a switch because the outrigger is either up or down. In other applications of the invention, the outrigger sensor could include load sensors, extension sensors and angle sensors. The output of all these sensors go into an analog to digital converter, item 110. The analog to digital converter may be a variety of types. The analog to digital converter may be a capacitor charged and then discharged by a resistor where the micro-controller times the amount of time required to discharge the capacitor. If the sensor is a switch, the sensor can be connected directly into a micro-controller, item 100. Some micro-controller have an analog to digital converters integrated into the micro-controller. This converted signal is then scaled using a scale factor, regression equation or look-up table by the micro-controller to provide a load, angle, or position. The micro-controller will then combine the information from the multiple sensors with the information on the capacity of the equipment to determine if the equipment is being operated within the capacity of the equipment. The micro-controller can be connected to a real time clock that maintains the time of day and date if there is a loss of power to the device. The micro-controller can be connected to memory, item 140. The memory may be a variety of types including RAM or EEPROM or other types that allow data to be saved a retrieved. The calibration and use information can be stored into the memory. This memory may also include information on the equipment such as date of manufacturing, serial number and model number. Different model numbers may be different size and include different features such as reach and capacity. The model number may also indicate if the equipment includes outriggers or if the outriggers are adjustable of fixed extension. The memory may store information on the number of miles or operational hours of the equipment. In the preferred embodiment, the memory includes information on overload conditions that include the time and date of the overload, the conditions when the overload, magnitude, load, extension, location of the load, incline of the boom, rotation of the boom, and condition of the outriggers, in addition to the magnitude of the overload. The micro-controller can be connected to a user interface that may include buttons 150 and a display 40 that can provide information from each of the sensors and the combined interaction of all the sensors on the equipment. The combined information can be given as a percentage of the capacity of the equipment, graphical information of audible information. When the operator loads the equipment beyond the capacity of the equipment the microprocessor can signal the operator with a visual or audible alarm item 160. The micro-controller may also disable the operation of the equipment until the operator reduces the load to a safe capacity.

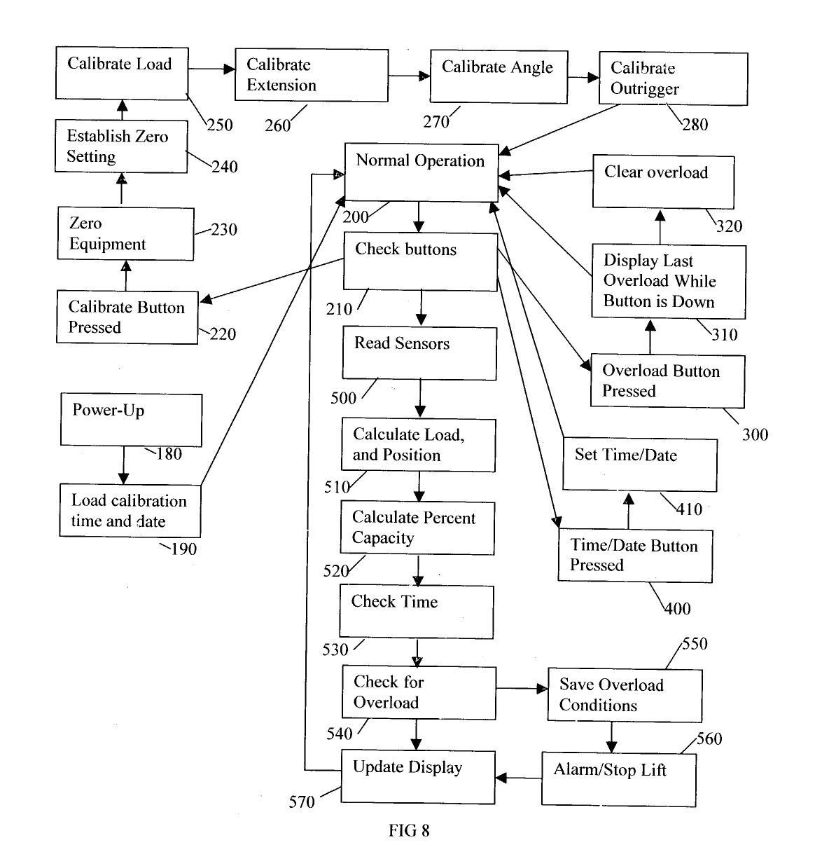

FIG. 7 is an example of the user interface of the preferred embodiment. The display 40, show the operator the time of day 41, and date 46, load 42, extension 43, angle 45, and the capacity of the equipment 44. The display is updated in a real time manner so the operator can get information on the load being lifted as the load is being lifted. Three buttons are shown in FIG. 7 that allow the operator to enter information. Pressing the middle button 48 will begin the calibration sequence. While in the calibration sequence pressing the right button will increase a value, and pressing the left button will decrease the value. Pressing the − button 47 in the normal operation mode will change the display from pounds to kilograms or other units. Pressing the + button, item 49 will show any stored overloads, or equipment usage information. Additional feature can be obtained using other key combinations that allow clearing of overloads, and zeroing the sensors without requiring a complete calibration sequence button 49.

Referring to FIG. 8 that shows a flow chart of the calibration and operation of the equipment. When power is initially 180 applied to the invention, the will invention will perform a power up test to determine if it was previously in operation. The microprocessor performs this test by looking for calibration information. If no calibration information is available, the microprocessor will load default factors for the zero and scale factors 190. If calibration information was previously saved then the microprocessor will load the previous configuration information. The calibration information may contain zero values, scale factor information, date of last calibration, equipment usage information, serial number, equipment type. The microprocessor may also perform a system check that may include testing the gauges, memory, display and any other user interface function. In the preferred embodiment, the information includes the load on the equipment, extension of the boom, angle of the boom, and a percentage of the capacity of the equipment. After initialization, the invention will enter the operation mode 200.

The normal operation mode is where the invention monitors or checks the buttons 210. If a calibration button is pressed 220 the invention will enter a calibration mode. When the calibration mode is entered, the operator can calibrate the equipment. The display will prompt the user to remove all loads from the equipment and return any extensions to known zero location, rotation, to home position or other known position item 230. This is done to establish a base unloaded zero condition 240. Once the equipment is in this condition the operator will press a button to indicate that the equipment is ready. After the user presses the button the equipment will read one or all the gauges and verify that the gauges are within an acceptable limit. If the gauges are outside an acceptable limit then the user will be prompted to correct the problem. If the readings are acceptable then the micro-controller will save the gauge values as base value or values. The user will then be prompted to place a known weight on the equipment, and press the button again. After the button is pressed, the micro-controller will again verify that the readings are acceptable. If the readings are outside an acceptable range the user will be prompted to correct the trouble. If the reading is acceptable then the micro-controller will save the value as a scale factor or adjust the reading and then save the adjusted value 250. This process may be repeated for a multiple of sensors, locations, positions or loads. As an example of the adjustment, if the user loads 2,000 pounds on the equipment and receive a count of 146 for this load. The micro-controller will divide the 146 counts by 2,000 pounds and save in memory a calibration of 7.3 counts per 100 pounds. After this calibration factor is loaded into memory the user will be prompted to calibrate another function of the equipment like the boom by extending the boom 10 feet, and incline the boom by 10 degrees.

The user presses the button again and the micro-controller will determine the difference the zero reading and this new reading. The difference may be scaled based upon the extension 260 and or the angle 270 to determine a scale factor for these two sensors and save the scale factor into memory. Additional calibration information can be performed like calibrating the extension of outriggers 280, or determining the calibration at additional loads, locations, angles, inclines or rotations. After the calibration is complete the zero and scale factor values may be saved into memory so the factors are available if power is lost. Following the calibration function the display will return to normal operation.

If the user presses a time/date, set button 400, the time and date can be set. Pressing this user interface button allows the time or day value to increase or decrease 410. A button allows the user to switch between adjustable items. After the time and date adjustment is complete, the invention will return to the normal operation mode. The time and date may also be adjusted or set by the invention automatically if the invention is able to receive the time and date from a wireless connection from a satellite, cell phone or other technology. The invention may also get location information from GPS, cell phone or other technology that locates the equipment.

If the user presses or holds down an overload button 300, the device will display any overload conditions 310. If another button is pressed the invention will clear any previously stored overload conditions, or accumulated information 320 and return to normal operation.

In the normal operation mode if no buttons are dressed, the device will read each of the sensors either one at a time or all sensors at the same time 500. The invention may use a look-up table to determine the load. In the preferred embodiment the invention will calculate the load and position by first reading the sensor, subtracting away the zero value, and then multiplying the remainder of the reading by the calibration factor 510. An example of this type equation is shown below.

$$Load = \frac{Sensor reading - Sensor Zero}{Scale Factor}$$

The micro-controller will combine the factors from multiple sensors, using look-up tables or mathematical equations or relationships to determine the loading on the equipment.

The invention will combine the loading information from some or all the sensors to calculate the percentage of capacity 520. The invention will check the time of day 530. The invention will then check for an overload condition 540. If an overload condition exists, the invention will save the overload 550. The invention may take a number of actions following an overload such as sound an alarm 560, flash a light or prevent the lift. The invention will then update the display 570, and then return to the normal operation mode.

Thus, specific embodiments and applications for determining the safe lifting capacity of lifting equipment have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A device that determines a safe lifting capacity of a lifting apparatus comprising:
a first sensor capable of determining a load being lifted;
at least a second sensor capable of determining a location of the load being lifted;
a summing mechanism for summing the load and the location of the load, and
a user interface mechanism to provide information on the load.

2. The device of claim 1 wherein the first and second sensor is a strain gauge, piezo sensor, scale, pressure sensor, variable resistor, variable capacitor, variable inductor, load cell, inclinometer, angle, rotation, angle, displacement, and position sensor.

3. The device of claim 1 wherein the summing mechanism is a computer, micro-controller, and programmable logic controller.

4. The device of claim 1 wherein the user interface mechanism contains buttons, switches, knobs, dials, display, memory, sound and lights.

5. The display of claim 4 wherein the display is LED, LCD, and CRT.

6. The device of claim 1 further includes a mechanism to prevent usage of the equipment if the load exceeds a threshold.

7. A device that determines the location of a load on a lifting device comprising:
a first sensor capable of determining the extension of a load being lifted;
at least a second sensor capable of determining the angle of the load being lifted,
a summing mechanism for summing the extension and the angle of the load being lifted, and
a user interface to provide information on the location of the load being lifted.

8. The device of claim 7 wherein the first and second sensor is a strain gauge, piezo sensor, scale, pressure sensor, variable resistor, variable capacitor, variable inductor, load cell, inclinometer, angle, rotation, angle, displacement, and position sensor.

9. The device of claim 7 wherein the summing mechanism is a computer, micro-controller, and programmable logic controller.

10. The device of claim 7 wherein the user interface mechanism contains buttons, switches, knobs, dials, display, memory, sound and lights.

11. The display of claim 10 wherein the display is LED, LCD, and CRT.

12. The device of claim 1 further includes a mechanism to prevent usage of the equipment if the load exceeds a threshold.

13. A device that determines when the capacity of the piece of lifting equipment was exceeded comprising:
a piece of lifting equipment configured to determine at least one parameter of a load being lifted;
a computing means capable of determining when a capacity of the lifting equipment exceeds a threshold;
a time and or date keeping apparatus;
a storage means for storing attributes when the threshold was exceeded, and
a user interface means for providing information on when the parameter of the exceeded capacity occurred.

14. The device of claim 13 wherein the lifting equipment is configures with a strain gauge, piezo sensor, scale, pressure sensor, variable resistor, variable capacitor, variable inductor, inclinometer, and load cell.

15. The device of claim 13 wherein the time and or date keeping apparatus is a real-time-clock, timer, stop watch, count up timer, count down timer, and atomic clock.

16. The device of claim 13 wherein the storage means is RAM, ROM, EEPROM, bubble memory, flash memory, hard drive, floppy drive, and CDROM.

17. The device of claim 13 wherein the user interface mechanism contains buttons, switches, knobs, dials, display, memory, sound and lights.

18. The display of claim 17 wherein the display is LED, LCD, and CRT.

19. The device of claim 13 wherein the storage means can contain at least one event.

20. The device of claim 13 further includes a mechanism to prevent usage of the equipment if the load exceeds a threshold.
